(19) United States
(12) Patent Application Publication
(10) Pub. No.: US 2021/0084690 A1
(43) Pub. Date: Mar. 18, 2021

(54) Controlling Selection of a Random Access Procedure in a Communication Network

(71) Applicant: GOOGLE LLC, Mountain View, CA (US)

(72) Inventor: Shiangrung Ye, New Taipei City (TW)

(21) Appl. No.: 17/024,621

(22) Filed: Sep. 17, 2020

Related U.S. Application Data
(60) Provisional application No. 62/901,770, filed on Sep. 17, 2019.

(51) Int. Cl. H04W 74/08; H04W 72/12; H04W 72/04

(52) U.S. Cl. CPC H04W 74/0833; H04W 72/044; H04W 72/1289

(57) ABSTRACT

A communication device such as a UE or a base station grants or gains access to a communication channel using a random access channel procedure. The communication device communicates (e.g., transmits, receives) an indication of which type of RACH procedure, in a set including a two-step RACH procedure of a first type and a two-step RACH procedure of a second type, a UE is to perform (902). The indication is transmitted from a base station to the UE via a radio interface. The communication device performs a RACH procedure of the indicated type to grant or gain access of the UE to the communication channel (904).

### FIELD OF THE DISCLOSURE

This disclosure relates generally to wireless communications and, more particularly, to procedures for granting or gaining access to a communication channel.

### BACKGROUND

To synchronize communication over a radio interface, a user equipment (“UE”) and a base station can use a random access channel (RACH) procedure. Generally speaking, a RACH procedure begins when a UE sends a random access (RA) preamble to the base station. There are contention-based RACH procedures during which a UE randomly selects a preamble from a certain predefined set of patterns or signatures, and a base station can receive identical preambles from two or more UEs during the same physical-layer random-access channel (PRACH) occasion, i.e., a time-frequency resource for transmitting information to the base station in the uplink direction. The base station can resolve the contention between UEs transmitting identical preambles using additional messaging. On the other hand, to initiate a contention-free RACH procedure, a UE sends a preamble which the base station previously assigned specifically to the UE to thereby eliminate contention between UEs transmitting identical preambles.

During a four-step contention-based RACH procedure, (1) a user device sends a random access preamble to a base station (“Msg1”); (2) the base station sends a random access response (RAR) to the user device (“Msg2”); (3) the user device sends a scheduled transmission to the base station (“Msg3”); and (4) the base station sends a contention resolution to the user device (“Msg4”). When the UE already has an assigned preamble, the UE can perform a two-step contention-free procedure by generating a Random Access Radio Network Temporary Identifier (RA-RNTI) based on the parameters of the time-frequency resource defining a PRACH occasion (e.g., carrier identifier, slot identifier), send the previously assigned preamble to the base station (“Msg1”), receive the RAR from the base station (“Msg2”), and decode the RAR using the RA-RNTI.

Further, in some cases it is possible for the UE to conduct a contention-based RACH procedure as a two-step procedure. In particular, a two-step contention-based procedure condenses steps (1) and (3) of the four-step procedure into a first step and steps (2) and (4) into a second step, such that (1) a user device sends a random access preamble and a scheduled transmission to the base station (“MsgA”); and (2) the base station sends an RAR and contention resolution to the user device (“MsgB”).

However, even when a UE and a base station are configured to support both contention-based and contention-free RACH procedures, there are no mechanisms for the base station to specify to the UE which of these RACH procedures the UE should initiate.

### SUMMARY

To control access to a communication channel, a base station of this disclosure indicates to the UE whether the UE is to perform a two-step contention-based random access procedure or a two-step contention-free random access procedure. In some cases, the base station selects the RACH procedure from a set including, in addition to the two-step contention-based procedure and the two-step contention-free procedure, a four-step contention-based procedure, and provides a corresponding indication to the UE.

In some implementations, the base station provides an explicit indication of the RACH procedure in a Physical Downlink Control Channel (PDCCH) order message including Downlink Control Indicator (DCI). For example, the DCI can include a binary flag that specifies the two-step contention-based procedure or two-step contention-free procedure. As another example, the DCI can include a multi-bit flag that specifies the two-step contention-based procedure, two-step contention-free procedure, and at least one other procedure such as the four-step contention-based procedure.

In other implementations, the base station indicates the selection of the RACH procedure using certain dedicated values of the random access preamble index. For example, the base station can transmit specifically to the UE, or broadcast in one or more cells, the mapping of value V₁ to the two-step contention-based procedure (and, in some cases, the mapping of value V₂ to the four-step contention-based procedure). The base station then includes the random access preamble index in the DCI of the PDCCH order. The UE can perform the two-step contention-based procedure in response to receiving the value V₁, use the random access preamble indexed by value V≠V₁, and perform the two-step contention-free RACH procedure.

Further, the base station can associate a PRACH occasion with a certain type of the RACH procedure. Thus, the base station can indicate to the UE that occasions in a set SO₁ correspond to the two-step contention-based RACH procedure, and that occasions in a set SO₂ correspond to the two-step contention-free RACH procedure. The base station then can indicate in the PDCCH order whether the UE is to perform the RACH procedure during an occasion that belongs to the set SO₁ or an occasion that belongs to the set SO₂, and thereby also specify the type of the RACH procedure the UE is to use.

Still further, the base station can associate a Control Resource Set CORESET (which is a frequency resource over which the base station transmits a DCI, at a periodically occurring time defined by a search space) with a certain type of the RACH procedure. Thus, the base station can indicate to the UE that CORESET C₁ corresponds to the two-step contention-based RACH procedure, and that CORESET C₂ corresponds to the two-step contention-free RACH procedure. When UE receives a PDCCH order (the DCI) over CORESET C₁, the UE performs the two-step contention-based RACH procedure; when UE receives a PDCCH order over CORESET C₂, the UE performs the two-step contention-free RACH procedure.

The base station also can combine at least some of the techniques above to provide additional indications. For example, the base station can use both sets of PRACH occasions and dedicated values (and/or multiple sets) of the random access preamble index to indicate whether the RACH is procedure is a two-step procedure or a four-step procedure, and whether the procedure is contention-based and contention-free.

One example embodiment of these techniques is a method in a communication device for granting or gaining access to a communication channel. The method can be executed using processing hardware. The method includes communicating an indication of which type of a random access channel (RACH) procedure, in a set including a two-step RACH procedure of a first type and a two-step RACH procedure of a second type, a UE is to perform. The indication is transmitted from a base station to the UE via a radio interface. The method further performing a RACH procedure of the indicated type to grant or gain access of the UE to the communication channel.

Another embodiment of these techniques is a method in a communication device for granting or gaining access to a communication channel, which can be executed using processing hardware. The method includes communicating an indication of which of at least a first type, a second type, or a third type of a RACH procedure a UE is to perform. The indication is transmitted from a base station to the UE via a radio interface. The method also includes performing the determined RACH procedure of the indicated type to grant or gain access of the UE to the communication channel.

Yet another example embodiment of these techniques is a base station comprising hardware and configured to implement at least one of the methods above.

Still another example embodiment of these techniques is a UE comprising hardware and configured to implement at least one of the methods above.

### BRIEF DESCRIPTION OF THE DRAWINGS

FIG. 1 illustrates an example communication system in which a base station and/or a UE can implement the techniques of this disclosure for granting, or gaining access to, a communication channel using a random access channel (RACH) procedure;

FIG. 2A is a messaging diagram of a known four-step contention-based RACH procedure;

FIG. 2B is a messaging diagram of a known two-step contention-free RACH procedure;

FIG. 2C is a messaging diagram of a known two-step contention-based RACH procedure;

FIG. 3A is a messaging diagram of an example scenario in which a base station configures a UE with certain resources corresponding to particular types of a RACH procedure, and indicates the selection of a resource in a Physical Downlink Control Channel (PDCCH) order;

FIG. 3B is a messaging diagram of an example scenario in which a base station indicates, using a PDCCH order, to the UE which type of a RACH procedure the UE is to perform;

FIG. 4A is a flow diagram of an example method for controlling the selection of a RACH procedure at a UE using two or more sets of random access preambles and a random access preamble index, which can be implemented in the base station of FIG. 1;

FIG. 4B is a flow diagram of an example method for selecting a RACH procedure in the UE of FIG. 1, when the base station implements the method of FIG. 4A;

FIG. 5A is a flow diagram of an example method for controlling the selection of a RACH procedure at a UE by associating sets of physical-layer random-access channel (PRACH) occasions with RACH procedure types, which can be implemented in the base station of FIG. 1;

FIG. 5B is a flow diagram of an example method for selecting a RACH procedure in the UE of FIG. 1, when the base station implements the method of FIG. 5A;

FIG. 6A is a flow diagram of an example method for controlling the selection of a RACH procedure at a UE by associating sets of PRACH occasions with RACH procedure types and using a random access preamble index to indicate, which can be implemented in the base station of FIG. 1;

FIG. 6B is a flow diagram of an example method for selecting a RACH procedure in the UE of FIG. 1, when the base station implements the method of FIG. 6A;

FIG. 7A is a flow diagram of an example method for controlling the selection of a RACH procedure at a UE by associating CORESETs with RACH procedure types, which can be implemented in the base station of FIG. 1;

FIG. 7B is a flow diagram of an example method for selecting a RACH procedure in the UE of FIG. 1, when the base station implements the method of FIG. 7A;

FIG. 8A is a flow diagram of an example method for controlling the selection of a RACH procedure at a UE by associating CORESETs with RACH procedure types and using a random access preamble index, which can be implemented in the base station of FIG. 1;

FIG. 8B is a flow diagram of an example method for selecting a RACH procedure in the UE of FIG. 1, when the base station implements the method of FIG. 8A; and

FIG. 9 is a flow diagram of an example method for gaining or granting access to a communication channel, which can be implemented in the base station of the UE of FIG. 1.

### DETAILED DESCRIPTION OF THE DRAWINGS

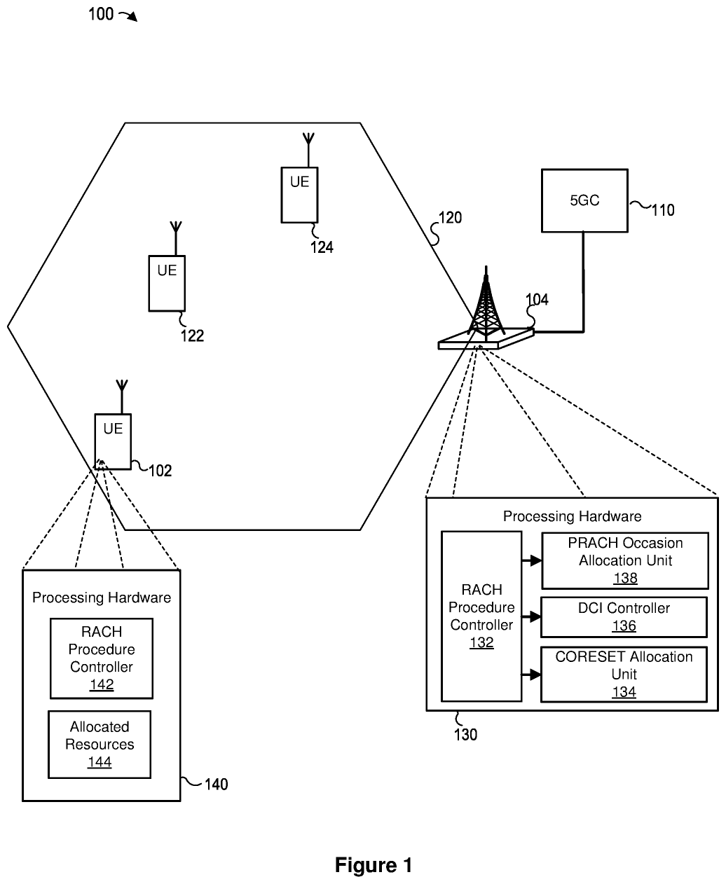

FIG. 1 depicts an example wireless communication network 100 in which a UE 102 synchronizes communication with a base station 104, and gains access to a communication channel in a cell of the base station 104, using a RACH procedure. The UE 102 and the base station 104 support several types of RACH procedures, including a contention-based two-step RACH procedure and a two-step contention-free RACH procedure. As discussed in detail below, the base station 104 determines which type of the RACH procedure the UE 102 should perform and provides an indication of the RACH procedure to the UE 102. The UE 102 and the base station 104 then perform the RACH procedure of the indicated type.

The UE 102 can be any suitable device capable of wireless communication. The base station 104 in this example operates as a g Node B (gNB) and supports 5G New Radio (NR) radio access technology (RAT). The base station 104 is connected to a core network (CN) 110 of CN type 5GC. In other implementations, however, the wireless communication network 100 can include one or more base stations that operate according to RATs of types other than NR, and these base stations can be connected to CNs of other CN types.

The base station 104 covers a 5G NR cell 120 in which other devices, such as UEs 122 and 124 for example, can operate and sometimes attempt to gain access to the same channel as the UE 102.

As illustrated in FIG. 1, the base station 104 is equipped with processing hardware 130 that can include one or more general-purpose processors such as central processing units (CPUs) and non-transitory computer-readable memory storing machine-readable instructions executable on the one or more general-purpose processors, and/or special-purpose processing units.

The UE 102 is equipped with processing hardware 120 that can include one or more general-purpose processors such as CPUs and non-transitory computer-readable memory storing machine-readable instructions executable on the one or more general-purpose processors, and/or special-purpose processing units. The processing hardware 120 in an example implementation includes a RACH procedure controller 132 that determines which RACH procedure the UE 102 is to perform and provides a corresponding indication to the UE 102. To provide an indication of the RACH procedure, the RACH procedure controller 132 can cooperate with a CORESET allocation unit 134, a DCI controller 136, and/or a PRACH occasion allocation unit 138.

The CORESET allocation unit 134 can configure the UE 102 with one or more CORESETs or, more generally, resources with time and/or frequency components, over which the base station 104 can transmit (and the UE 102 accordingly can receive) control parameters such as time-domain resource assignment, frequency-domain resource assignment, an indication of a modulation and coding scheme, etc. As one example, the base station 104 can provide these control parameters in a DCI. As discussed below, the CORESET allocation unit 134 in some implementations allocates CORESETs so that when the base station 104 transmits a DCI over a certain CORESET, the UE 102 selects a certain RACH procedure, but when the base station 104 transmits the DCI over another CORESET, the UE 102 selects another RACH procedure.

The DCI controller 136 can format a DCI which the base station 104 transmits to the UE 102 in a PDCCH order message. The DCI controller 136 can include an explicit indication of the RACH procedure the UE 102 is to perform (e.g., as a binary flag or a multi-bit flag) or an implicit indication of the RACH procedure (e.g., by assigning a certain value or range to the random access preamble index), as discussed in more detail below.

The PRACH occasion allocation unit 138 can configure the UE 102 with time-frequency resources over which the UE 102 can transmit the first message of the RACH procedure. These time-frequency resources can be PRACH occasions, for example. The PRACH occasion allocation unit 138 in one implementation configures the UE 102 with multiple sets of PRACH occasions, so that the UE 102 can initiate a RACH procedure of one type over a PRACH occasion in one set, and the a procedure of another type over a PRACH occasion in another set. The base station 104 can indicate to the UE 102 which PRACH occasion the UE 102 is to use using an explicit or implicit indication. These techniques also are discussed in more detail below.

With continued reference to FIG. 1, the UE 102 is equipped with processing hardware 140 that can include one or more general-purpose processors such as central processing units (CPUs) and non-transitory computer-readable memory storing machine-readable instructions executable on the one or more general-purpose processors, and/or special-purpose processing units. The processing hardware 120 in an example implementation includes a RACH procedure controller 142 that determines which RACH procedure the UE 102 is to perform in accordance with an indication from the base station 104. The RACH procedure controller 142 to this end can use allocate resources 144 that can include CORESET information, PRACH occasions, etc.

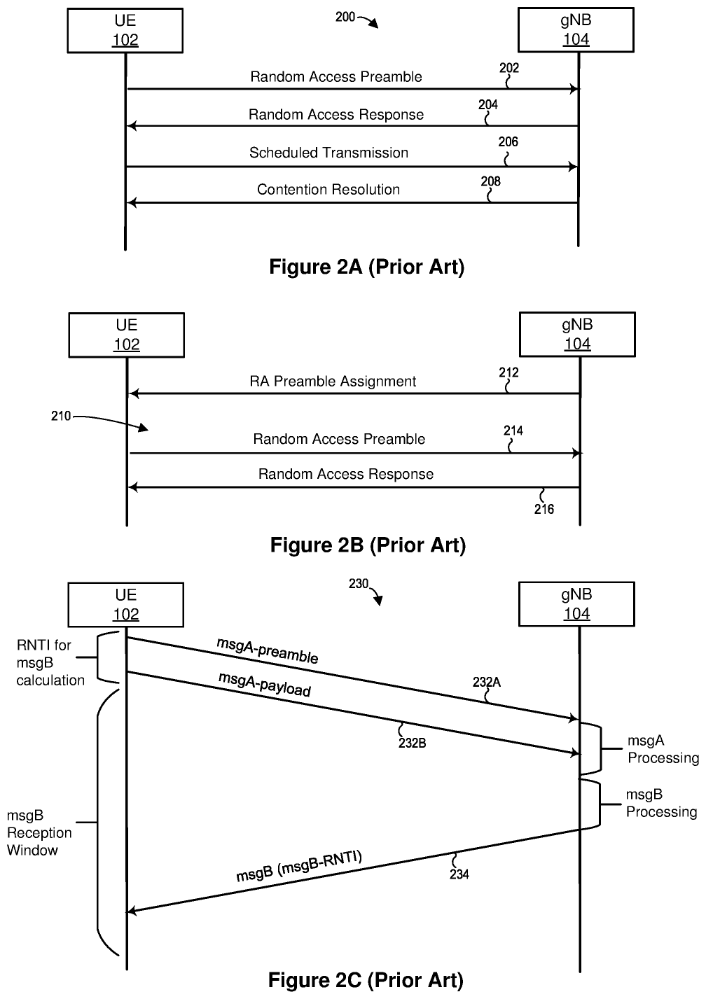

Next, FIG. 2A-C illustrate several examples of known RACH procedures the UE 102 and the base station 104 can perform. To more clearly illustrate the timing restrictions of the two-step contention-based RACH procedure, FIG. 2C depicts the propagation delay of messages traveling over a radio interface using slanted lines.

Referring first to FIG. 2A, a four-step contention-based RACH procedure 200 begins when the UE 102 selects a time-frequency resource defining a PRACH occasion and sends 202 an RA preamble during the selected PRACH occasion to the gNB 104 (“Msg1”). The UE 102 then calculates an RA-RNTI using the following formula:

RA_RNTI=1+s_id+14*t_id+14*80*f_id+14*80*8*ul_carrier_id,

where s_id is the index of the first orthogonal frequency-division multiplexing (OFDM) symbol occurring in the PRACH occasion (0≤s_id≤14), t_id is the index of the first slot of the PRACH occasion in a system frame (0≤t_id≤80), f_id is the index of the PRACH occasion in frequency domain (0≤f_id≤8), and ul_carrier_id is the uplink (UL) carrier over which the UE 102 transmitted the random access preamble (0 for the normal uplink (NUL) carrier and 1 for the supplementary uplink carrier (SUL)).

After the gNB 104 receives 202 the random access preamble, the gNB 104 responds by sending 204 an RAR to the UE 102 (“Msg2”). The gNB 104 encodes the RAR so that the UE 102 can decode the RAR using the RA-RNTI. The UE 102 then sends 206 a scheduled transmission to the gNB 104 (“Msg3”), and the gNB 104 in response sends 208 a contention resolution to the user device (“Msg4”).

FIG. 2B illustrates a two-step contention-free RACH procedure 210, which the UE 102 and the gNB 104 also can support. Prior to the UE 102 initiating the RACH procedure 210, the gNB 104 assigns an RA preamble and sends 212 the RA preamble to the UE 102. The gNB 104 in this manner eliminates contention from the RACH procedure. The UE 102 at a later time begins the two-step contention-free RACH procedure 210 by sending 214 the assigned RA preamble to the gNB 104 during a PRACH occasion (“MsgA”). The gNB 104 sends 216 an RAR in response (“MsgB”). The UE 102 generates an RA-RNTI and decodes the RAR using the RA-RNTI similar to the RACH procedure 200 discussed above.

Next, FIG. 2C illustrates a two-step contention-based RACH procedure 230. The UE 102 according to this procedure transmits 232A an RA preamble and also transmits 232B a payload, during a PRACH occasion. The preamble and the payload together define MsgA. In other words, the RA preamble and the payload correspond to Msg1 and Msg2, respectively, of the four-step contention-based RACH procedure 200 of FIG. 2A. The UE 102 transmits the two portions of MsgA over different time and radio resources. As further illustrated in FIG. 2C, the UE 102 calculates a msgB-RNTI based on the PRACH occasion during which the UE 102 transmitted the preamble portion of MsgA. The gNB 104 processes MsgA and generates MsgB within respective time intervals, and sends 234 MsgB to the UE 102. The UE 102 decodes MsgB using the msgB-RNTI, if the UE 102 receives 234 within the MsgB reception window.

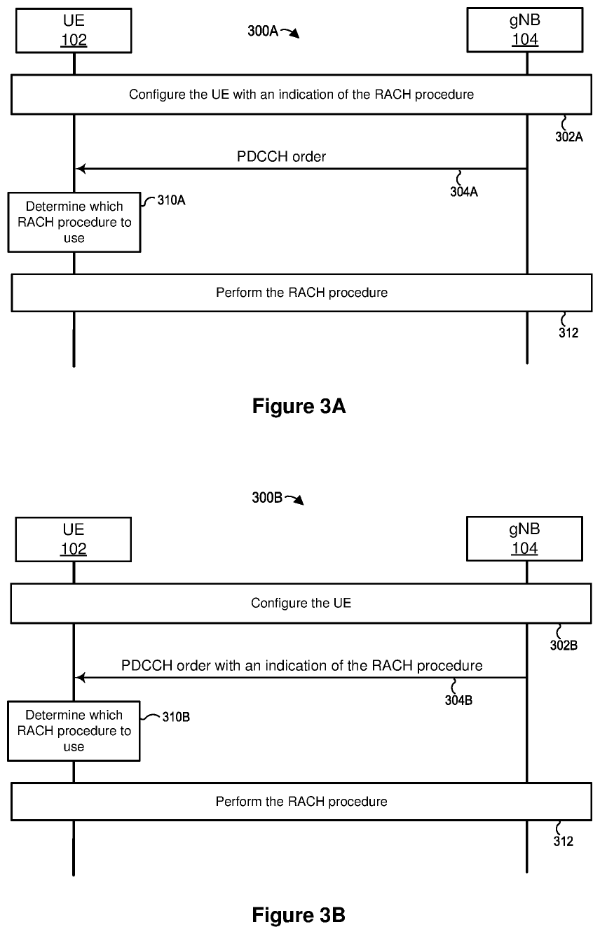

Next, various techniques the UE 102 and the base station 104 can implement to perform a RACH procedure of a particular type are discussed with reference to FIGS. 3A-9. Generally speaking, the techniques discussed below include communicating, from the gNB 104 to the UE 102 during configuration of the UE 102, an indication of how the UE 102 is to select a RACH procedure (FIG. 3A), and/or communicating which the UE 102 is to perform when triggering a RACH procedure via a PDCCH order (FIG. 3B). As used in this disclosure, the term “communicating” can refer to transmitting or receiving information. Thus, for example, communicating an indication of a selected RACH procedure can refer to the gNB 104 transmitting the indication or to the UE 102 receiving the information.

Referring to FIG. 3A, the gNB 104 in an example scenario 300A configures 302A the UE 102 with certain parameters including an indication of how the UE 102 is to select a RACH procedure. The configuration information the gNB provides 302A can include for example a set of RA preambles, a set of PRACH occasions, and a set of physical uplink shared channel (PUSCH) occasions, which are time-frequency resources over which the UE 102 can transmit data to the gNB 104 on a PUSCH (in contrast to PRACH occasions, which the UE 102 uses to transmit an RA preamble). The gNB 104 also can configure 302A the UE 102 with association between PRACH and PUSCH occasions. Thus, when the UE 102 selects a PRACH occasion to transmit an RA preamble, the UE 102 also selects a corresponding PUSCH occasion in accordance with these associations.

To configure 302A the UE 102, the gNB 104 in some implementations performs a configuration or reconfiguration procedure at the level of a protocol for controlling radio resources on the radio interface between the UE 102 and the gNB 104. As a more specific example, the gNB 104 can perform a Radio Resource Control (RRC) reconfiguration procedure defined in 3GPP TS 38.331 and transmit an RRCReconfiguration message to the UE 102. The RRCReconfiguration message in this implementation includes one or more information elements (IEs) to specify RA preambles, PRACH occasions, PUSCH occasions, etc.

In another implementation, the gNB 104 configures 302A the UE 102 when setting up a radio connection associated with a protocol for controlling radio resources. As a more specific example, the gNB 104 can perform an RRC connection establishment procedure defined in 3GPP TS 38.331 and transmit an RRCSetup message to the UE 102.

In yet another implementation, the gNB 104 configures 302A the UE 102 when re-establishing a radio connection associated with a protocol for controlling radio resources. For example, the gNB 104 can perform an RRC re-establishment procedure defined in 3GPP TS 38.331 and transmit an RRCReestablishment message to the UE 102.

In still another implementation, the gNB 104 configures 302A the UE 102 when resuming a previously suspended radio connection associated with a protocol for controlling radio resources. The gNB 104 for example can perform an RRC connection resume procedure defined in 3GPP TS 38.331 and transmit an RRCResume or RRCSetup message to the UE 102.

As one alternative to sending configuration information specifically to the UE 102 as discussed above, the gNB 104 can broadcast the configuration information to devices operating in the cell 120 in a System Information Block (SIB) such a Master Information Block (MIB) or SIB type 1 (SIB1).

In some implementations, during the UE-specific or broadcast configuration procedure corresponding to event 302, the gNB 104 indicates which one or more dedicated values of the RA preamble index identify certain types of RACH procedures. For example, the gNB 104 can indicate that when the UE 102 receives an RA preamble index with value V₁, the UE 102 is to perform a two-step contention-based RACH procedure, and when the UE 102 receives an RA preamble index with a value other than V₁, the UE 102 is to perform a two-step contention-free RACH procedure using the RA preamble the RA preamble index identifies.

Further, the gNB 104 in some implementations configures the UE 102 with more than one dedicated value V₁, V₂, . . . V_{N}. As a more specific example, the gNB 103 can configure the UE 102 to initiate a four-step contention-based RACH procedure when the UE 102 receives an RA preamble index with value V₁, a two-step contention-based RACH procedure when the UE 102 receives an RA preamble index with value V₂, and a two-step contention-free RACH procedure when the RA preamble index is neither V₁ nor V₂. In one such implementation, V₁=0, and V₂ is the minimum or maximum value of the RA preamble index. Thus, when the gNB 104 uses six bits to specify the value of the RA preamble index (which accordingly varies in the range between zero and 63), V₁=0 and V₂=1 or 63.

In another implementation, the UE 102 and the gNB 104 are preconfigured with one or more dedicated values V₁, V₂, . . . V_{K}. The gNB 104 in this implementation does not need to explicitly the UE 102 with the dedicated values.

In some implementations, the gNB 104 configures 302A the UE 102 with several sets of RA preambles. The gNB 104 for example can indicate that the N available RA preambles belong to two sets, RA preamble set SP₁ {P₁, P₂, . . . P_{L}} and RA preamble set SP₂={P_{L+1}, P_{L+2}, . . . P_{N}}. The sets SP₁ and SP₂ need not be of equal size. Further, depending on the implementation, the one or more dedicated values V₁, V₂, etc. can belong to one of the sets PS₁ or PS₂ or be outside the sets PS₁ and PS₂. When the gNB 104 configures 302A the UE 102 with multiple sets of RA preambles, the UE 102 can selects RA preambles from different sets to perform different RACH procedures. For example, the gNB 104 can configure the UE 102 to perform a two-step contention-based RACH procedure using an RA preamble from set SP₁, a four-step contention-based RACH procedure using an RA preamble from set SP₂, and a two-step contention-free RACH procedure using a specified RA preamble that belongs to set SP₁ or SP₂.

Further, the gNB 104 in some implementations configures 302A the UE 102 with multiple sets of time-frequency resources for transmitting a random access preamble, e.g., PRACH occasions. The gNB 104 for example can indicate that a set of PRACH occasions SO₁ is made up of occasions O₁, O₂, etc. and a set of PRACH occasions SO₂ is made up of occasions O_{J}, O_{J+1}, etc. The sets SO₁ and SO₂ need not be of equal size. The gNB 104 can configure the UE 102 to perform a two-step contention-based RACH procedure using a PRACH occasions from set SO₁, a four-step contention-based RACH procedure using a PRACH occasions from set SO₂, and a two-step contention-free RACH procedure using a PRACH occasion that belongs to set SO₁ or SO₂.

In some implementations, the gNB 104 configures 302A the UE 102 with for multiple time-frequency resources over which the UE 102 can receive from the gNB 104 control parameters for processing downlink transmissions a channel, e.g., a DCI. These time-frequency resources can include CORESETs, for example. The gNB 104 can configure the UE 102 to perform a two-step contention-based RACH procedure when the UE 102 receives a PDCCH order message over a CORESET C₁ and perform a four-step contention-based RACH procedure when the UE 102 receives a PDCCH order message over a CORESET C₂. More generally, the gNB 104 can configure the UE 102 with any suitable number of CORESETs or sets of multiple CORESETs and indicate, by selecting a certain CORESET for transmitting a PDCCH order, which of the two, three, or four types of RACH procedures the UE 102 is to perform.

With continued reference to FIG. 3A, the gNB 104 at some point can send 304A a PDCCH order message to the UE 102. The UE 102 can determine 310A which RACH procedure to perform based on the received PDCCH order message and in accordance with the configuration of event 302. As discussed below, the gNB 104 can use one of the techniques discussed above (e.g., dedicated values of the RA preamble index) or a combination of more than one of these techniques (e.g., dedicated values of the RA preamble index and sets of PRACH occasions associated with types of RACH procedures). The UE 102 then can perform 312 the determined RACH procedure.

Thus, for example, when the gNB 104 configures 302A the UE 102 with dedicated values V₁ and V₂ of the RA preamble index, the UE 102 can perform a two-step contention-based RACH procedure in response to receiving V₁ in the RA preamble index, a four-step contention-based RACH procedure in response to receiving V₂ in the RA preamble index, and a two-step (or four-step) contention-free procedure using the RA preamble identified by the RA preamble index in response to receiving a value other than V₁ or V₂ in the RA preamble index.

As another example, when the gNB 104 configures 302A the UE 102 with preamble sets SP₁ and SP₂ discussed above, the UE 102 can select an RA preamble from set SP₁ and perform a two-step contention-based RACH procedure, when the value of the RA preamble index is V₁. The value V₁ in this case need not identify an RA preamble in the preamble set SP₁. In another scenario, however, the value V₁ identifies an RA preamble in the preamble set SP₁, and the UE 102 can select any RA preamble from set SP₁, including the RA preamble identified by V₁. When the value of the RA preamble index is V₂, the UE 102 can select an RA preamble from set SP₂ and perform a four-step contention-based RACH procedure. When the value V₂ identifies an RA preamble in the preamble set SP₂, the UE 102 can select any RA preamble from set SP₂, including the RA preamble identified by V₂. Further, in some implementations, when the UE 102 receives a third value V₃ (e.g., the lowest or the highest index in the set SP₁), the UE 102 also can select an RA preamble from set SP₁ and perform a two-step contention-based RACH procedure, or use the RA preamble identified by V₃. When the value of the RA preamble index is none of V₁, V₂, or V₃, the UE 102 performs a two-step contention-free RACH procedure using the RA preamble identified by the RA preamble index.

According to another example, when the gNB 104 configures 302A the UE 102 with sets of PRACH occasions SO₁ and SO₂, the UE 102 selects a PRACH occasion from set SO₁ and performs a two-step contention-based RACH procedure, when the value of the RA preamble index is V₁. The UE 102 selects a PRACH occasion from set SO₂ and performs a four-step contention-based RACH procedure, when the value of the RA preamble index is V₂. Further, according to this example configuration, the UE 102 selects a PRACH occasion either from set SO₁ or SO₂ and performs a two-step (or four-step, depending on the implementation) contention-free RACH procedure, when the value of the RA preamble index is neither V₁ nor V₂.

In another example implementation, the gNB 104 similarly configures 302A the UE 102 with sets of PRACH occasions SO₁ and SO₂. However, the gNB 104 in this case indicates which PRACH occasion the UE 102 is to use via the PDCCH order message (e.g., via a suitable flag or IE). When the UE 102 determines that the indicated PDCCH occasion belongs to set SO₁, the UE 102 performs a two-step contention-based RACH procedure. When the UE 102 determines that the indicated PDCCH occasion belongs to set SO₂, the UE 102 performs a four-step contention-based RACH procedure. Alternatively, the UE 102 can perform a two-step contention-free RACH procedure when the indicated PDCCH occasion belongs to set SO₂.

In yet another example implementation, the gNB 104 configures 302A the UE 102 with sets of PRACH occasions SO₁ and SO₂ as well as at least one set of RA preambles. The UE 102 receives 304A from the gNB 104 a PDCCH order message indicating that the UE should use a certain PRACH occasion. When the UE 102 determines that the PRACH occasion is in the set SO₁, and that the value of the RA preamble index is V₁, the UE 102 performs a two-step contention-based RACH procedure and transmits an RA preamble over the indicated PRACH occasion. When the UE 102 determines that the PRACH occasion is in the set SO₁, but the value of the RA preamble index is not V₁, the UE 102 performs a two-step (or four-step) contention-free RACH procedure and transmits the RA preamble identified by the RA preamble index over the indicated PRACH occasion. Further, when the UE 102 determines that the PRACH occasion is in the set SO₂, and that the value of the RA preamble index is V₂, the UE 102 performs a four-step contention-based RACH procedure and transmits an RA preamble over the indicated PRACH occasion. When the UE 102 determines that the PRACH occasion is in the set SO₂, but the value of the RA preamble index is not V₂, the UE 102 performs a two-step (or four-step) contention-free RACH procedure and transmits the RA preamble identified by the RA preamble index over the indicated PRACH occasion.

As another example, when the gNB 104 configures 302A the UE 102 with two or more CORESETs, the UE 102 performs a two-step contention-based RACH procedure if the UE 102 receives a PDCCH order over the first CORESET, and a four-step contention-based RACH procedure if the UE 102 receives a PDCCH order over the second CORESET. Alternatively, the UE 102 can perform a two-step contention-free RACH procedure when the UE 102 receives a PDCCH order over the second CORESET.

In still other implementations, the gNB 104 configures 302A the UE 102 with two or more CORESETs and configures at least one set of RA preambles for the UE 102 to perform a two-step or four-step contention-free RACH procedure. If the UE 102 receives a PDCCH order over the first CORESET, and the RA preamble index is V₁, the UE 102 performs a two-step contention-based procedure. If the UE 102 receives a PDCCH order over the first CORESET, but the RA preamble index is not V₁, the UE 102 performs a contention-free procedure (e.g., a two-step contention-free procedure) using an RA preamble identifies by the RA preamble index. If the UE 102 receives a PDCCH order over the second CORESET, and the RA preamble index is V₂, the UE 102 performs a four-step contention-based procedure. If the UE 102 receives a PDCCH order over the second CORESET, but the RA preamble index is not V₂, the UE 102 performs a contention-free procedure (e.g., a four-step contention-free procedure) using an RA preamble identifies by the RA preamble index. In one such implementation, the UE 102 performs a two-step RACH procedure when the RA preamble index is not V₁ or V₂, regardless of the CORESET over which the UE 102 received a PDCCH order.

FIG. 3B illustrates an example scenario 300B that is generally similar to the scenario 300A. However, the selection of the RACH procedure at the UE 102 in this implementation does not depend on configuration event 302B. The gNB 104 indicates to the UE 102, using a PDCCH order message, which type of a RACH procedure the UE 102 is to perform. To this end, the gNB 104 can use a dedicated binary flag or a multi-bit field, and the UE 102 can be pre-configured to determine 310B the type of the RACH procedure the UE 102 is to perform based on the value of the flag or field (V₁, V₂, etc.).

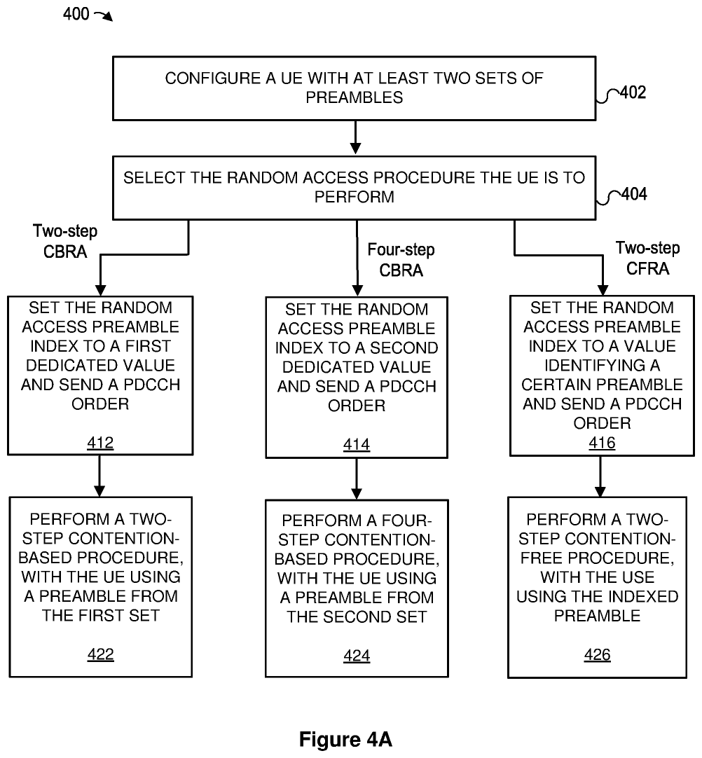

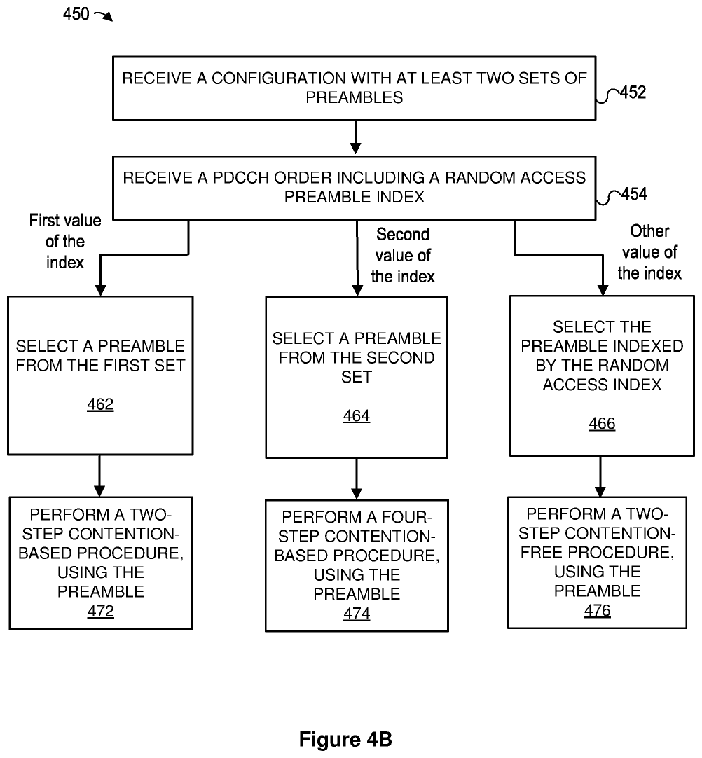

For further clarity, FIGS. 4A 9 illustrate several example methods which the UE 102 and/or the gNB 104 can implement to control the selection of a RACH procedure.

Referring first FIG. 4A, an example method 400 can be implemented in the gNB 104 or another suitable base station. The method 400 begins at block 402, where the gNB 104 configures the UE 102 with at least two sets of RACH preambles. Next, at block 404, the gNB 104 selects the type of a RACH procedure the UE 102 is to perform. When the gNB 104 selects a two-step contention-based RACH procedure, the flow proceeds to block 412; when the gNB 104 selects a four-step contention-based RACH procedure, the flow proceeds to block 414; and when the gNB 104 selects a two-step contention-free RACH procedure, the flow proceeds to block 416.

At block 412, the gNB 104 sets the RA preamble index to a first dedicated value (e.g., V₁) and sends a PDCCH order message. The gNB 104 then performs a two-step contention-based RACH procedure, in response to the UE 102 sending an RA preamble from the first set (block 422). At block 414, the gNB 104 sets the RA preamble index to a second dedicated value (e.g., V₂) and sends a PDCCH order message. At block 424, the gNB 104 performs a four-step contention-based RACH procedure, in response to the UE 102 sending an RA preamble from the second set. At block 416, the gNB 104 sets the RA preamble index to a value identifying an RA preamble the UE 102 is to use (neither V₁ nor V₂) and sends a PDCCH order message. At block 426, the gNB 104 performs a two-step contention-free RACH procedure in response to the UE 102 sending the indicated RA preamble.

FIG. 4B illustrates an example method 450 which the UE 102 or another suitable UE can implement. The method 450 begins at block 452, where the UE 102 receives from the gNB 104 a configuration including at least two sets of RACH preambles. Next, at block 454, the UE 102 receives a PDCCH order message including an RA preamble index. When the UE 102 determines that the RA preamble index has a first value (e.g., V₁), the UE 102 at block 462 selects an RA preamble from the first set and performs a two-step contention-based RACH procedure using the selected RA preamble, at block 472. When the UE 102 determines that the RA preamble index has a second value (e.g., V₂), the UE 102 at block 464 selects an RA preamble from the second set and performs a four-step contention-based RACH procedure using the selected RA preamble, at block 474. When the UE 102 determines that the RA preamble index has a value other than the first value and the second value, the UE 102 at block 466 selects the RA preamble identified by the RA preamble index and performs a two-step contention-free RACH procedure using the selected RA preamble, at block 476.

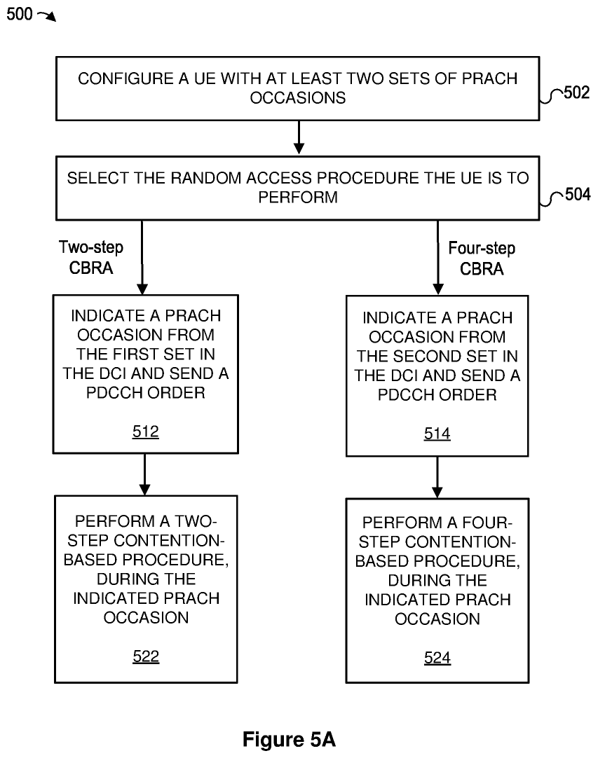

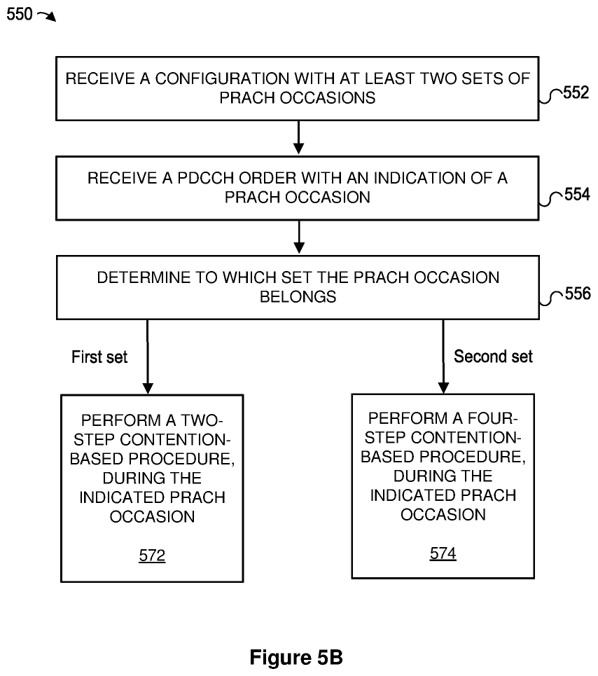

Now referring to FIG. 5A, an example method 500 can be implemented in the gNB 104 or another suitable base station. The method 500 begins at block 502, where the gNB 104 configures the UE 102 with at least two sets of PRACH occasions. Next, at block 504, the gNB 104 selects the type of a RACH procedure the UE 102 is to perform. When the gNB 104 selects a two-step contention-based RACH procedure, the flow proceeds to block 512, but when the gNB 104 selects a four-step contention-based RACH procedure, the flow proceeds to block 514. At block 512, the gNB 104 sends a PDCCH order message indicating the selection of a PRACH occasion in the first set and, at block 522, performs a two-step contention-based RACH procedure. At block 514, the gNB 104 sends a PDCCH order message indicating the selection of a PRACH occasion in the second set and, at block 524, performs a four-step contention-based RACH procedure.

FIG. 5B illustrates an example method 550 which the UE 102 or another suitable UE can implement. The method 550 begins at block 552, where the UE 102 receives from the gNB 104 a configuration including at least two sets of PRACH occasions. Next, at block 554, the UE 102 receives a PDCCH order message including an indication of a PRACH occasion. The UE 102 then determines to which of the two sets the indicated PRACH occasion belongs, at block 556. When the UE 102 determines that the PRACH occasion belongs to the first set, the UE 102 at block 572 performs a two-step contention-based RACH procedure during the indicated PRACH occasion. When the UE 102 determines that the PRACH occasion belongs to the second set, the UE 102 at block 574 performs a four-step contention-based RACH procedure during the indicated PRACH occasion.

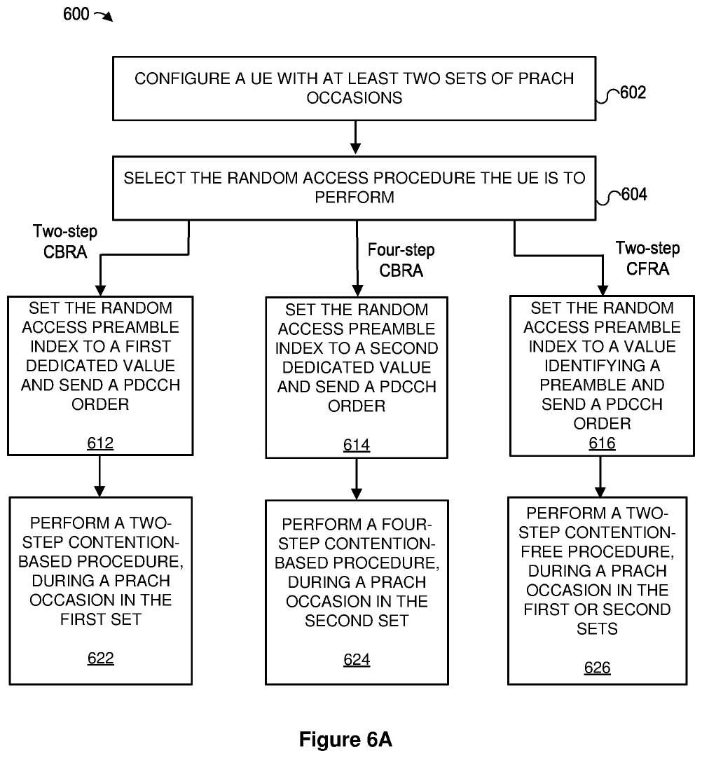

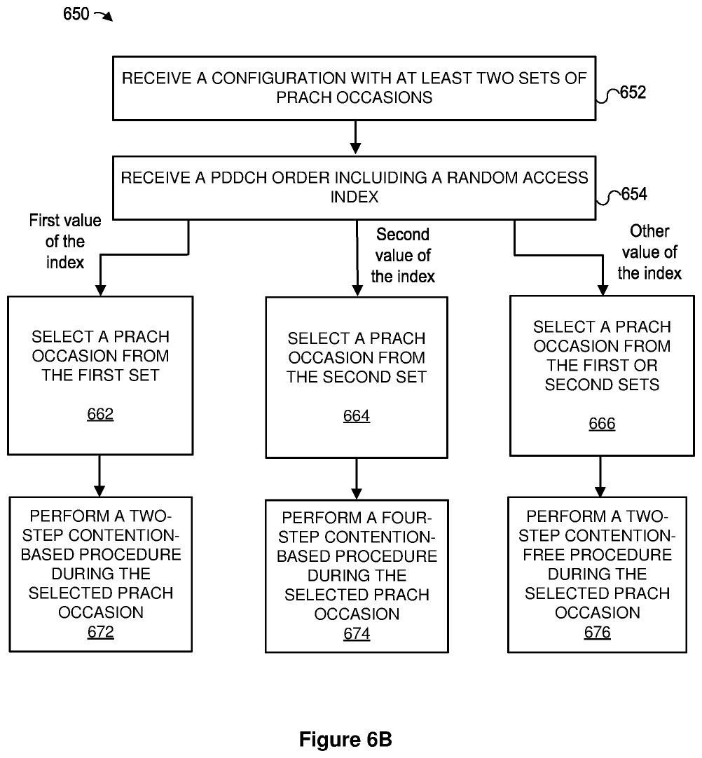

Next, FIG. 6A illustrates is an example method 600 which the gNB 104 or another suitable base station can implement. At block 602, the gNB 104 configures the UE 102 with at least two sets of PRACH occasions. Next, at block 604, the gNB 104 selects the type of a RACH procedure the UE 102 is to perform. When the gNB 104 selects a two-step contention-based RACH procedure, the gNB 104 sends a PDCCH order message including an RA preamble set to a first dedicated value (e.g., V₁) at block 612. The gNB 104 then performs a two-step contention-based RACH procedure, during a PRACH occasion in the first set, at block 622. When the gNB 104 selects a four-step contention-based RACH procedure, the gNB 104 at block 614 sends a PDCCH order message including an RA preamble set to a second dedicated value (e.g., V₂). At block 624, the gNB 104 performs a two-step contention-based RACH procedure, during a PRACH occasion in the second set. Finally, when the gNB 104 selects a two-step contention-free RACH procedure, the gNB 104 sends a PDCCH order message including a selected RA preamble at block 616. The gNB 104 then performs a two-step contention-based RACH procedure, during a PRACH occasion in the first or second set, at block 626.

FIG. 6B illustrates an example method 650 which the UE 102 or another suitable UE can implement. The method 650 begins at block 652, where the UE 102 receives from the gNB 104 a configuration including at least two sets of PRACH occasions. Next, at block 654, the UE 102 receives a PDCCH order message including an RA preamble index. When the UE 102 determines that the RA preamble index has a first value (e.g., V₁), the UE 102 at block 662 selects a PRACH occasion from the first set and performs a two-step contention-based procedure during the selected PRACH occasion, at block 672. When the UE 102 determines that the RA preamble index has a second value (e.g., V₂), the UE 102 at block 664 selects a PRACH occasion from the second set and performs a four-step contention-based procedure during the selected PRACH occasion, at block 674. When the UE 102 determines that the RA preamble index has a value other than the first value and the second value, the UE 102 at block 766 selects a PRACH occasion from the first or second sets and performs a two-step contention-based procedure during the selected PRACH occasion, at block 776.

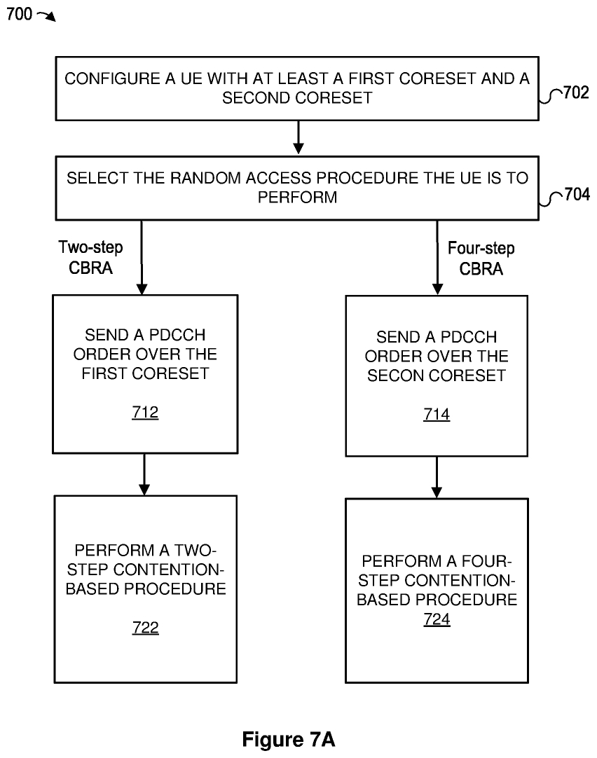

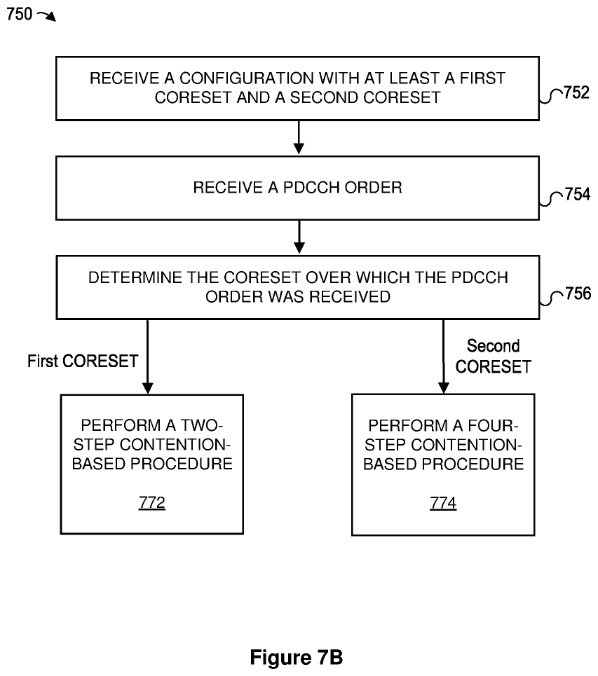

Referring next to FIG. 7A, an example method 700 can be implemented in the gNB 104 or another suitable base station. The method 700 begins at block 702, where the gNB 104 configures the UE 102 with at least two CORESETs (e.g., C₁ and C₂). Next, at block 704, the gNB 104 selects the type of a RACH procedure the UE 102 is to perform. When the gNB 104 selects a two-step contention-based RACH procedure, the flow proceeds to block 712, but when the gNB 104 selects a four-step contention-based RACH procedure, the flow proceeds to block 714. At block 712, the gNB 104 sends a PDCCH order message over the first CORESET and performs 722 a two-step contention-based RACH procedure. At block 714, the gNB 104 sends a PDCCH order message over the second CORESET and, at block 724, performs a four-step contention-based RACH procedure.

FIG. 7B illustrates an example method 750 which the UE 102 or another suitable UE can implement. The method 750 begins at block 752, where the UE 102 receives from the gNB 104 a configuration including at least two CORESETs (e.g., C₁ and C₂). Next, at block 754, the UE 102 receives a PDCCH order message over a certain CORESET. The UE 102 then determines whether the CORESET over which the gNB 104 sent the PDCCH order is the first CORESET or the second CORESET, at block 756. When the UE 102 determines that the CORESET is the first CORESET, the UE 102 at block 772 performs a two-step contention-based RACH procedure. When the UE 102 determines that the CORESET is the second CORESET, the UE 102 at block 774 performs a four-step contention-based RACH procedure.

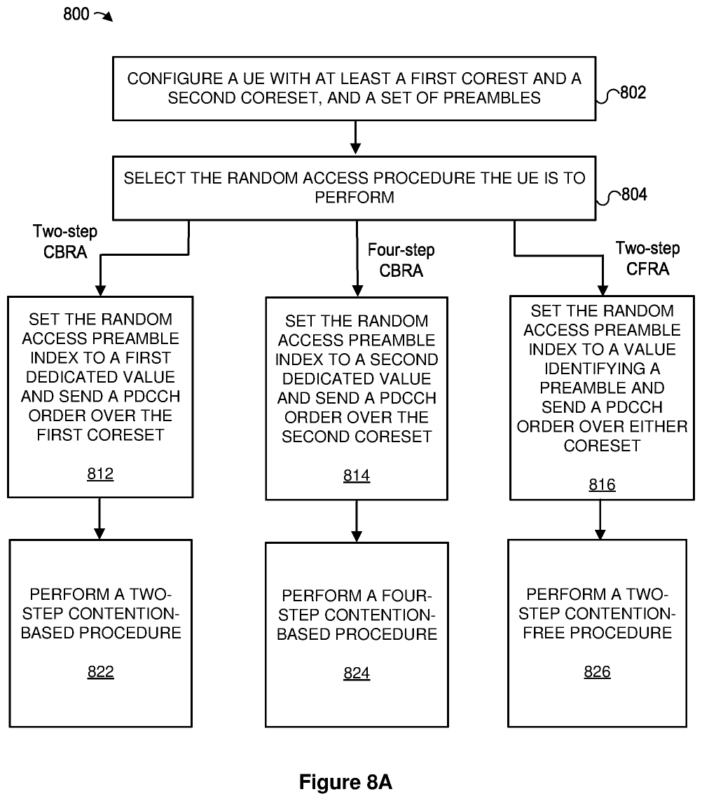

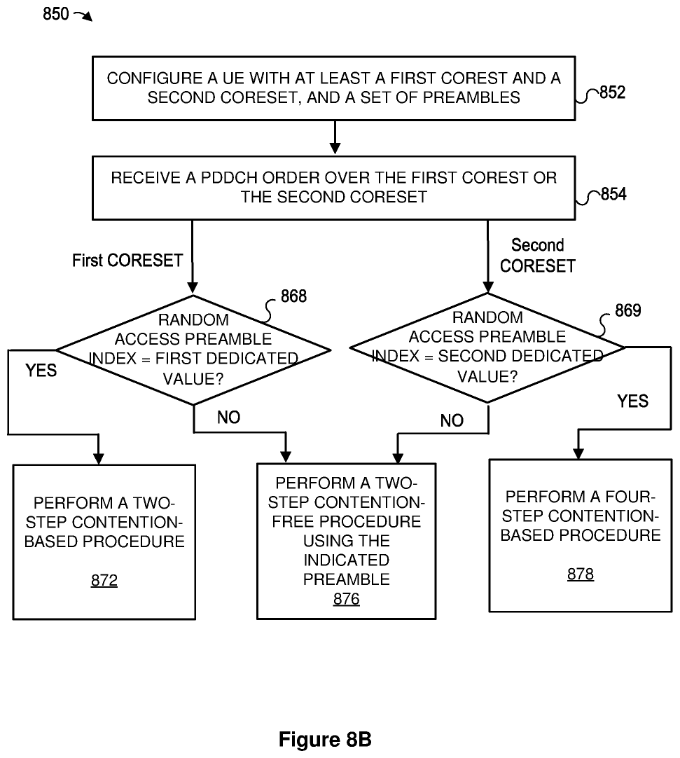

Next, FIG. 8A illustrates an example method 800, which the gNB 104 or another suitable base station can implement. At block 802, the gNB 104 configures the UE 102 with at least two CORESETs (e.g., C₁ and C₂) at least one set of RA preambles. At block 804, the gNB 104 selects the type of a RACH procedure the UE 102 is to perform. When the gNB 104 selects a two-step contention-based RACH procedure, the flow proceeds to block 812; when the gNB 104 selects a four-step contention-based RACH procedure, the flow proceeds to block 814; and when the gNB 104 selects a two-step contention-free RACH procedure, the flow proceeds to block 816.

At block 812, the gNB 104 sets the RA preamble index to a first dedicated value (e.g., V₁) and sends a PDCCH order message over the first CORESET. The gNB then performs a two-step contention-based RACH procedure at block 822. At block 814, the gNB 104 sets the RA preamble index to a second dedicated value (e.g., V₂) and sends a PDCCH order message over the second CORESET. The gNB then performs a four-step contention-based RACH procedure at block 824. At block 816, the gNB 104 sets the RA preamble index to value identifying an RA preamble and sends a PDCCH order message over the first or second CORESET. The gNB then performs a two-step contention-free RACH procedure at block 826.

Now referring to FIG. 8B, an example method 850 which the UE 102 or another suitable UE can implement. The method 850 begins at block 852, where the UE 102 receives from the gNB 104 a configuration including at least a first CORESET, a second CORESET, and a set of RA preambles. At block 854, the UE 102 receives from the gNB 104 a PDCCH order message over the first CORESET or second CORESET. If the UE 102 receives the PDCCH order message over the first CORESET, the flow proceeds to block 868; otherwise, if the UE 102 receives the PDCCH order message over the second CORESET, the flow proceeds to block 869.

If the UE 102 determines at block 868 that the RA preamble index has a first predefined value, the flow proceeds to block 872; otherwise, the flow proceeds to block 876. If the UE 102 determines at block 869 that the RA preamble index has a second predefined value, the flow proceeds to block 872; otherwise, the flow proceeds to block 876. At block 872, the UE 102 performs a two-step contention-based procedure. At block 878, the UE 102 performs a four-step contention-based procedure. Otherwise, at block 876, the UE 102 performs a two-step contention-free procedure using the indicated RA preamble.

Referring to FIGS. 8A and 8B, the gNB 104 and the UE 102 in some implementations use the same dedicated value (e.g., V₁) to indicate the selection of the two-step contention-based RACH procedure as well as the selection of the four-step contention-based RACH procedure (and rely on the CORESET to differentiate between the two-step and four-step contention-based RACH procedures).

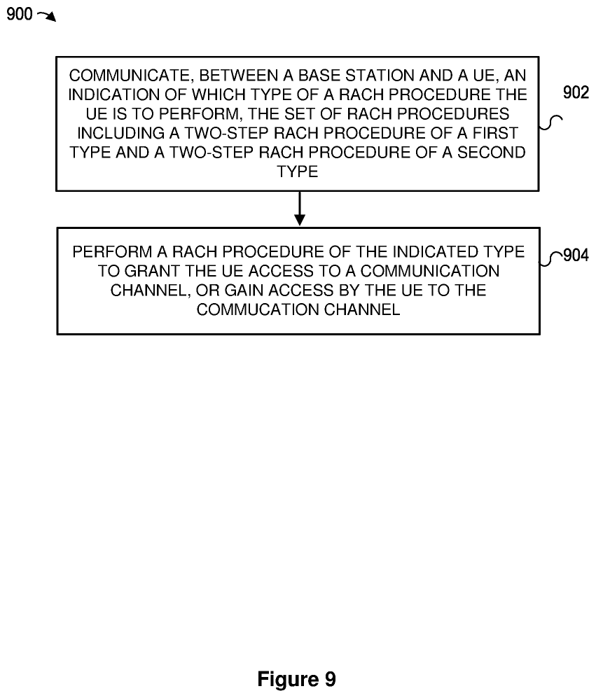

Finally, FIG. 9 illustrates an example method 900 for gaining or granting access to a communication channel, which can be implemented in a communication device such as the gNB 104 or the UE 102. At block 902, the communication device communicates, between the gNB 104 and the UE 102, an indication of a RACH procedure the UE 102 is to perform (see, e.g., event 302A and 304A, or 302B and 304B; block 402 and blocks 414-416; blocks 452 and 454; block 502, 512, and 514; blocks 552 and 554; blocks 602 and blocks 612-616; block 652 and 654; block 702, 712, and 714; blocks 752 and 754; blocks 802 and 812-816; blocks 852 and 854). In some implementations, the RACH procedure belongs to a set including a two-step RACH procedure of a first type (e.g., contention-free) and a two-step RACH procedure of a second type (e.g., contention-based).

Next, at block 904, the communication device performs the RACH procedure of the indicated type (see, e.g., event 312; blocks 422-426; blocks 472-476; blocks 522 and 524; blocks 572 and 574; blocks 622-626; blocks 672-676; blocks 722 and 724; blocks 772 and 774; blocks 822-826; and blocks 827-878).

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method in a communication device for granting or gaining access to a communication channel, the method comprising:
communicating, by processing hardware, an indication of which type of a random access channel (RACH) procedure, in a set including a two-step RACH procedure of a first type and a two-step RACH procedure of a second type, a user equipment (UE) is to perform, the indication transmitted from a base station to the UE via a radio interface; and
performing, by the processing hardware, a RACH procedure of the indicated type to grant or gain access of the UE to the communication channel.

2. The method of claim 1, wherein the two-step RACH procedure of the first type is a contention-based procedure, and the two-step RACH procedure of the second type is a contention-free procedure.

3. The method of claim 1, wherein the set further includes a four-step RACH procedure.

4. The method of claim 1, wherein communicating the indication includes:
communicating, by the processing hardware, a random access preamble index with a dedicated value to indicate selection of the two-step RACH procedure of the first type.

5. The method of claim 4, wherein communicating the indication includes, in another instance:
communicating, by the processing hardware, the random access preamble index with a value other than the dedicated value that specifies a random access preamble which the UE is to use to perform the two-step RACH procedure of the second type.

6. The method of claim 4, wherein:
the dedicated value is a first value, and
communicating the indication includes, in another instance:
communicating, by the processing hardware, the random access preamble index with a second value that indicates the selection of a four-step RACH procedure.

7. The method of claim 4, further comprising:
prior to communicating the random access preamble index with the dedicated value, communicating configuration data including the dedicated value, between the base station and at least the UE.

8. The method of claim 7, wherein communicating the configuration data includes communicating system information via a broadcast message with the configuration data, in at least one cell of the base station.

9. The method of claim 7, wherein communicating the configuration data includes communicating a radio resource control (RRC) message including the configuration data between the base station and the UE, during an RRC connection establishment procedure.

10. The method of claim 1, further comprising:
configuring, by the processing hardware, the UE with a first set of preambles and a second set of preambles; and
wherein communicating the indication includes communicating between the base station and the UE a random access preamble index with
(i) a first value to indicate that the UE is to select a preamble from the first set of preambles and perform a two-step contention-based RACH procedure,
(ii) a second value to indicate that the UE is to select to a preamble from the second set of preambles and perform a four-step contention-based RACH procedure,
(iii) a third value identifying a preamble in the first set of preambles, to indicate that the UE is to perform the two-step contention-based RACH procedure, using the identified preamble, or
(iv) a fourth value to indicate that the UE is to perform two-step contention-free RACH procedure, using a preamble identified by the fourth value.

11. The method of claim 1, wherein communicating the indication includes communicating a downlink control information (DCI) message including a binary flag with:
(i) a first value corresponding to the two-step RACH procedure of the first type, or
(ii) a second value corresponding to the two-step RACH procedure of the second type.

12. The method of claim 1, wherein communicating the indication includes communicating a DCI message including a multi-bit field with:
(i) a first value corresponding to the two-step RACH procedure of the first type,
(ii) a second value corresponding to the two-step RACH procedure of the second type, or
(iii) a third value corresponding to a four-step RACH procedure.

13. The method of claim 1, further comprising:
configuring, by the processing hardware, the UE with at least a first set of time-frequency resources and a second set of time-frequency resources, such that the UE can initiate the two-step RACH procedure of the first type only over a time-frequency resource in the first set and cannot initiate the two-step RACH procedure of the first type over a time-frequency resource in the second set,
wherein communicating the indication includes communicating which of the sets of time-frequency resources and/or which time-frequency resource the UE is to use for performing the RACH procedure of the indicated type.

14. The method of claim 13, wherein the first and second sets of time-frequency resources define occasions on a physical-layer random-access channel (PRACH).

15. The method of claim 13, wherein communicating the indication includes communicating, between the base station and the UE, a random access preamble index with:
(i) a first value to indicate that the UE is to select a time-frequency resource from the first set and perform a two-step contention-based RACH procedure,
(ii) a second value to indicate that the UE is to select a time-frequency resource from the second set and perform a four-step contention-based RACH procedure, or
(iii) a third value to indicate that the UE is to select a time-frequency resource from the first set or the second set and perform a two-step contention-free RACH procedure, using a random access preamble indicated by the random access preamble index.

16. The method of claim 13, wherein communicating the indication includes communicating, between the base station and the UE, a DCI message that specifies a time-frequency resource in the first set or a second set such that:
(i) when the specified time-frequency resource is in the first set, the UE is to perform a two-step RACH procedure, and
(ii) when the specified time-frequency resource is in the second set, the UE is to perform a four-step contention-based RACH procedure.

17. The method of claim 13, wherein communicating the indication includes communicating, between the base station and the UE, a DCI message that specifies a time-frequency resource in the first set or a second set and includes a random access preamble index such that:
(i) when the time-frequency resource is in the first set and the random access preamble index has a first value, the UE is perform a two-step contention-based RACH procedure,
(ii) when the time-frequency resource is in the first set and the random access preamble index has a second value, the UE is to perform a two-step contention-free RACH procedure using a random access preamble identified by the random access preamble index, and
(iii) when the time-frequency resource is in the second set or the random access preamble index has a third value, the UE is to perform a four-step contention-based RACH procedure.

18. The method of claim 1, further comprising:
configuring, by the processing hardware, the UE with at least a first time-frequency resource and a second time-frequency resource during which the base station can transmit a DCI;
wherein communicating the indication includes communicating the DCI over the first time-frequency resource to indicate a selection of the two-step RACH procedure of the first type.

19. The method of claim 18, wherein communicating the indication includes:
communicating the DCI over the second time-frequency resource to indicate a selection of a four-step RACH procedure.

20. The method of claim 18, further comprising:
communicating the DCI over the first time-frequency resource or the second time-frequency resource, the DCI including a random access preamble index such that:
(i) when the DCI is communicated over the first time-frequency resource and the random access preamble index has a first value, the UE is to perform a two-step contention-based RACH procedure,
(ii) when the DCI is communicated over the first time-frequency resource and the random access preamble index has a value other than the first value, the UE is to perform a contention-free RACH procedure using a preamble indexed by the random access preamble index,
(iii) when the DCI is communicated over the second time-frequency resource and the random access preamble index has a second value, the UE is to perform a four-step contention-based RACH procedure, and
(iii) when the DCI is communicated over the first time-frequency resource and the random access preamble index has a value other than the second value, the UE is to perform a contention-free RACH procedure using a preamble identified by the random access preamble index.

21-26. (canceled)
